(19) United States
(12) Patent Application Publication
(10) Pub. No.: US 2017/0323382 A1
(43) Pub. Date: Nov. 9, 2017

(54) HEALTHCARE RELATED CLAIM RECONCILIATION

(71) Applicant: 3M Innovative Properties Company, St. Paul, MN (US)

(72) Inventor: Janice G. Ohlsson, Salt Lake City, UT (US)

(21) Appl. No.: 15/633,145

(22) Filed: Jun. 26, 2017

Related U.S. Application Data
(63) Continuation of application No. 11/612,078, filed on Dec. 18, 2006, now abandoned.

(51) Int. Cl. G06Q 40/02; G06Q 50/22; G06Q 10/08

(52) U.S. Cl. CPC G06Q 40/02; G06Q 10/087; G06Q 50/22

(57) ABSTRACT

Systems and methods for auditing and/or reconciling medical and financial data in a health record management software environment.

This application is a continuation of U.S. patent application Ser. No. 11/612,078, filed Dec. 18, 2006 and entitled “HEALTHCARE RELATED CLAIM RECONCILIATION,” the entire content of which is incorporated herein by reference.

### FIELD

The present invention relates to capturing and/or reconciling claim-related data in a health care management system.

### BACKGROUND

Healthcare costs continue to rise in developed countries and are estimated to reach over two trillion dollars a year in the U.S. alone. It is believed that as much as 25% of healthcare costs are administrative costs, as opposed to clinical costs. The costs of administering third party payment systems used in the healthcare industry are enormous. This is due, in part, to the difficulty in obtaining timely and efficient collection of payments from payment organizations (patients and third party payers (e.g., government agencies, insurance companies)), and monitoring and maintaining payer contracts.

A healthcare provider's failure to submit a claim to a payment organization correctly the first time can be costly, but such failure is not uncommon. In most healthcare organizations, a bill or claim is generated by administrative staff from numerous departments within the healthcare organization (such as a hospital). Typically, the bill is processed in the billing department where clinical, financial, and coded data about the medical services rendered are merged together. This merging of data may occur within five to seven days after the healthcare services are rendered to a patient.

The merged data is checked for accuracy either at the healthcare organization itself, at a claims clearinghouse, or both. Regardless of where accuracy checking takes place, if errors are found (i.e. coded data that does not meet federal billing requirements), the claims can be corrected by the healthcare organization before submission to a fiscal intermediary or third party payer, for payment.

This process of “back-end” correction contributes to high administrative cost of billing. The time that is spent correcting data can delay bill submission from two to three weeks or more. This delay, in turn, delays when the healthcare organization receives payment for services rendered.

### SUMMARY

In one embodiment, a system and method are provided for collecting, auditing, reconciling, and/or confirming healthcare-related claims data, and possibly for providing an indication of discrepancies related to the claims data. This may limit or reduce the number of claims denied by a payment organization.

### BRIEF DESCRIPTION OF THE DRAWINGS

FIG. 1 schematically illustrates an exemplary system for auditing medical and financial data in a health record management software environment.

FIG. 2 illustrates software modules of claim reconciliation system 1, as well as high-level data inputs and a database component.

FIG. 3 an example of tagged data format.

FIG. 4 is a flowchart illustrating an exemplary manner in which one embodiment of import and merge module 256 may function.

FIG. 5 shows an exemplary process that may be functionally invoked and effected by audit module 252.

FIG. 6 shows a further exemplary process that may be functionally invoked or effected by audit module 252.

FIG. 7 is a flowchart showing exemplary functionality of report generation module 253.

FIG. 8 shows an exemplary high-level process a user may use claim reconciliation system 1 to follow.

FIG. 9 through FIG. 15 are exemplary screenshots from one embodiment of a claim reconciliation system.

FIG. 16 through FIG. 19 are exemplary reports from one embodiment of a report generation module.

### DETAILED DESCRIPTION

The present invention now will be described more fully hereinafter with reference to accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

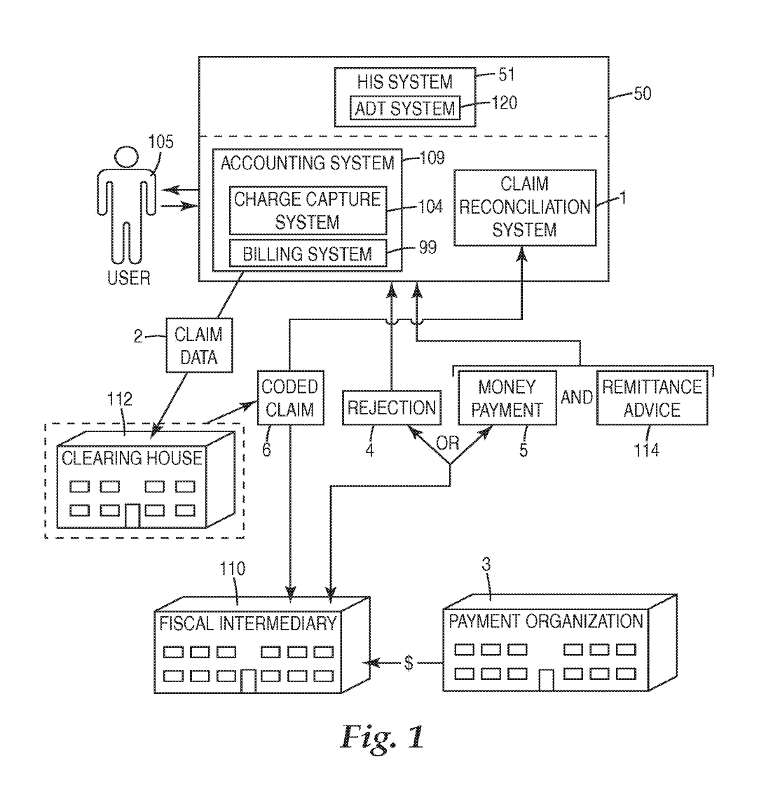

FIG. 1 is a diagram showing an exemplary high-level implementation of claim reconciliation system 1. Among other benefits, claim reconciliation system 1 may reduce or eliminate claims denied or rejected by a payment organization, so that a healthcare organization can receive payments in a timelier manner. Further, claim reconciliation system 1 may allow a healthcare organization, or other user interested in the benefits of the system, to identify and reduce or eliminate discrepancies between what was indicated proper for a claim made to a payment organization and that which was actually received from the payment organization. Further, claims-related errors and fraud may be more easily detected via claim reconciliation system 1 than with existing methods. In one embodiment, the system may facilitate auditing healthcare information in a software environment.

Treatment facility refers to any facility at which a patient receives healthcare-related treatment. Treatment facilities may be hospitals, clinics, urgent care clinics, ambulatory-only type facilities, or in-patient facilities. Treatment facilities may in turn have further treatment facilities. For example, some hospitals have satellite clinics located in areas more accessible to patients. One or more treatment facilities may combine billing and/or accounting activities. A healthcare organization is comprised of one or more treatment facilities which share an accounting and/or billing system. In other words, a healthcare organization may be an assembly of treatment facilities that use a centralized claim management system. For example, healthcare provider X may include two hospitals, each of which have a number of satellite offices. All but one of the satellite offices uses a common billing system. In this example, the satellite with its own billing would be both a treatment facility and a healthcare organization. The remaining treatment facilities comprise a separate healthcare organization. Various of the accounting and/or billing systems may be provided by a 3^{rd} party.

Claims, or bills, are the means by which healthcare organizations request payment for services rendered by treatment facilities. Claims are comprised of patient and provider demographics (basic information describing the patient or provider, such as name, birthday, etc.) and one or more line items which specify the services, treatments, medications, supplies, or other chargeable items or services associated with a treatment facility's encounter with a patient.

Healthcare organization typically has some type of information management system 50, which is used to manage operational details of the healthcare organization or its constituent treatment facilities, and/or accounting operations. Specific embodiments of information management system 50 vary widely, and may and often do contain further systems not specifically shown in the exemplary view shown in FIG. 1. However, it is not uncommon for a healthcare organization to have a health information system (HIS) 51, which may assist in managing operational logistics for a healthcare organization and/or its treatment facilities. For example, HIS system 51 may include an admissions, discharge, and transfer (ADT) system 120, which manages and tracks a patient from when the patient arrives at a treatment facility, to when the patient leaves the treatment facility. ADT system 120 may also collect basic demographic data for the patient, such as name, address, date of birth, and so forth.

Information management system 50 may also include accounting system 109, which manages financial accounting for the healthcare organization's operations. Accounting system 109, in some implementations, includes functionality whereby user 105 can review services provided to a patient at a treatment facility, and translate the services into line items which may be manually entered into accounting system 109, via charge capture system 104. User 105 is any user of any of the systems which may be found in a healthcare organization. For example, user 105 may be a coder, which is a person charged with reviewing data describing a healthcare organization's encounter with a patient, and converting that data into a set of codes describing the same. Charge capture system 104 may also import charges from other sources, or automatically code certain events. The process of reviewing a patient's records and converting them into properly line items is called coding. An example of a code base used by a healthcare organization includes one marketed by the American Medical Association under the trade designation Current Procedure Terminology, or CPT. CPT codes describe services rendered to a patient. Codes may be associated with demographic data collected from a patient via ADT system 120 on a patient record. A patient record is a record, sometimes electronic but often times paper (or both electronic and paper), that identifies the patient and includes all, or a subset of all, services rendered to that patient.

Accounting system 109 also, in some implementations, includes billing functionality (shown in FIG. 1 as billing system 99). Billing system 99 processes coded records and either scrubs them (a process whereby the claims are confirmed as-is, or formatted and otherwise adjusted to comply with claim submission standards of payment organization 3), or facilitates sending the coded records to clearinghouse 112, which in turn scrubs the record. Clearinghouse 112 may be a third party company setup to scrub claims. Claims, otherwise referred to as bills, and graphically illustrated in FIG. 1 as “Coded claim 6” are demands for payments, made to a payer (often in electronic form), for services rendered, often to a patient. Claims may be submitted to payers in various formats, one commonly used one of which is the HCFA Uniform Bill-92, or “UB-92.” A UB-92 compliant claim, as of Aug. 9, 2006, and according to website http://www.hipaanet.com/hisb_ub92.htm visited the same day, consists of fixed-length, 192 byte records, each record having a unique identifier and logically related data elements. The UB-92 format is designed to standardize and increase the submission of electronic claims and coordination of benefits exchange. It is used by healthcare organizations or other companies or people that submit claims for healthcare. The UB-92 format is also used to exchange healthcare claims and payment information between payers with different payment responsibility. Claim data 2 refers to the data from which claim 6 is based upon. In some instances claim data 2 may be coded in a format already compliant with submission to a fiscal intermediary. In other instances, claim data 2 is data used internally by a healthcare organization to document and/or describe a patient's encounter with that healthcare organization.

If clearinghouse 112 finds issues or errors with the claims, the claims may be sent back to the healthcare organization for correction or revision (not shown in FIG. 1). Returned claims are then dealt with by the healthcare organization on an ad hoc basis, which may be expensive and time consuming. The number of claims returned by a clearinghouse to a healthcare organization is thus attempted to be minimized. In certain embodiments, the use of claim reconciliation system 1 may reduce the number of records returned from a clearinghouse (or rejected by a fiscal intermediary for non-compliance or other reasons).

Once a clearinghouse has scrubbed claims 6 and the claims are ready for submission to a fiscal intermediary 110 for payment, the clearinghouse may submit the claims to fiscal intermediary 110 directly, on behalf of the healthcare organization, or may instead return the scrubbed record to the healthcare organization which in turn may submit the scrubbed claim itself. Usually, whichever entity scrubs the claims also submits them to fiscal intermediary 110 for payment. For the purposes of exemplary illustration, the remainder of this specification will presume the clearinghouse is used to scrub claims 6, then forwards claim 6 on to fiscal intermediary after or commensurate with having provided a copy of the scrubbed claims back to the healthcare organization, which puts the claim into a database (represented in FIG. 1 by the arrow going from coded claim 6 to claim reconciliation system 1) that is part of claim reconciliation system 1. Coded claims, if submitted to the fiscal intermediary by the clearinghouse, are usually also returned to the healthcare organization's information system 50.

Arrows in FIG. 1 generally represent data flows or communication. These data flows may be over a network, such as a telephone network, a local area network, and/or a wide area network. These networks may be public or private. The network may be the Internet.

Once a claim is scrubbed, the clearinghouse may estimate the amount of money expected to be received from the fiscal intermediary 110 on behalf of payment organization 3. This is referred to as the expected claim payment amount.

Fiscal intermediary 110 is usually a company hired by payment organization 3. Payment organization 3 is the party that provides the money to pay the claims, and may be referred to as the payer. Examples of payment organizations include the government (Medicare, for example) or insurance companies. A fiscal intermediary inspects and then provides to the healthcare organization payment 5 or rejection 4, along with remittance advice 114, all on behalf of payment organization 3. The process of inspection used by the fiscal intermediary 110 may be referred to as settlement. The claim settlement process often begins with confirming coverage eligibility for a patient and determining the appropriateness of care or services rendered to the patient. In addition, during the settlement process, fiscal intermediary 110 may interpret the claim data in light of some standard specified by payment organization 3 (such as ambulatory procedure codes for Medicare outpatient-based claims) and identify discrepancies between the claim as submitted and the standard. Fiscal intermediary 110 will then allocate the claim amount to various parties such as that portion paid by the patient (for example a co-pay), an insurance company, and/or the government (for example, Medicare). Other payment parties could also be involved as, for example, might be the case with an employer in the case of a workers compensation-related claim. Fiscal intermediary may also allocate a portion of the claim to that which has been reduced due to contractual negotiations. For example, given a $100 claim submitted to a fiscal intermediary, $10 may be determined to be received from the patient, $15 from another insurance provider, $20 from the fiscal intermediary, and the remainder will be allocated to a bucket that identifies reductions due to negotiated contracts with healthcare organizations. Fiscal intermediary 110 will determine which services rendered to a patient and described by codes, and the amount actually to be paid given those services. For example, if services were rendered to a patient that was ineligible to receive those services, the fiscal intermediary 110 may simply not pay the claim. Or, if line items have not been substantiated with documentation, as per a medical necessity edit for a payment, fiscal intermediary 110 will deny said line items, for example, and pay the remainder of claim 6. An edit, as the term is used herein, refers to an issue or potential issue. In this case, edit indicates the requirement of some piece of corroborating or supporting documentation, in support of a claim. For example, a medical necessity edit for a particular claim for a procedure means that claim will be denied unless a proper diagnosis is provided for in the records.

Remittance advice 114 is a record, usually electronic, which confirms the amounts paid into the organization's bank account on behalf of the payment organization as well as how much was paid for services rendered for each record/patient. Remittance advice 114 includes detail for line items of the submitted claim 6. This level of detail allows the healthcare organization to determine whether and why portions of a claim were not paid. The fiscal intermediary does not change claims; rather it only pays them or denies the claim or a portion thereof and explains, via the remittance advice, why it did what it did. In certain embodiments, claim reconciliation system 1 may facilitate a comparison between what was claimed and what was actually paid, per remittance advise 114. Claim reconciliation system 1 may allow the healthcare organization to find errors introduced into the claim during scrubbing processes, or during the initial coding of the claim. One or more embodiments contained herein may help identify and correct inconsistencies between what a healthcare organization expects to receive as payment from a fiscal intermediary on behalf of a payment organization, and what it actually receives as payment from the fiscal intermediary on behalf of a payment organization.

If payment 5 is made to the healthcare organization, the payment amount is posted to accounting system 109. If there is instead a full or partial rejection 4 of the claim, the healthcare organization can appeal the denied claims or adjust the claim and re-submit it to recover as much payment as is possible. It is advantageous to limit or eliminate claims rejected by fiscal intermediaries. In certain embodiments, claim reconciliation system 1 may limit or eliminate claims rejected by fiscal intermediaries.

From the time a patient receives billable services from a healthcare organization to the time the healthcare organization receives payment for those services, it is not uncommon for 45-120 days to elapse, depending largely on whether there are issues with the claim discovered by clearinghouse 112, or if the claim is rejected by fiscal intermediary 110. In some embodiment, claim reconciliation system 1 may reduce the average delay between rendering services to a patient and receiving payment for those services rendered.

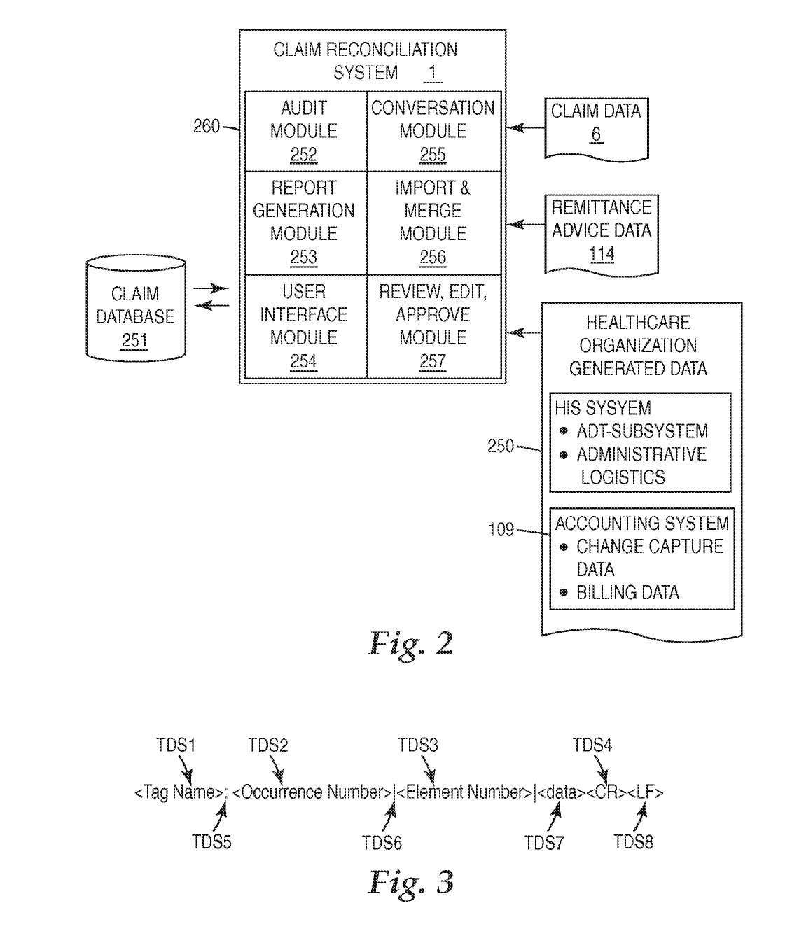

FIG. 2 is a diagram showing constituent software components and modules of one embodiment of claim reconciliation system 1. Claim reconciliation system 1 receives coded claim data 6, remittance advice data 114, and healthcare organization generated data 250. Healthcare organization generated data 250 may include any data the healthcare organization has available, but in the exemplary embodiment described herein, includes information from two general data sources: HIS system 51 and accounting system 109. In this exemplary embodiment of claim reconciliation system 1, data from HIS system 51 includes administrative logistics data describing a patient's encounter with a healthcare organization, such as that from the ADT system. At a high level, healthcare organization generated data may be considered the data describing the actual encounter with a patient. Accounting system 109 provides data associating particulars of the patient's encounter with the healthcare organization with proper coding and charges. Accounting system 109 provides information provided to clearing house 112, and in turn fiscal intermediary 110. As will be seen, claim reconciliation system 1, in one embodiment, receives these various inputs and may be able to determine discrepancies between what was submitted to clearing house 112, if and how clearing house 112 modified the information it received, what was submitted to fiscal intermediary 110, if fiscal intermediary accepted or rejected the information it received, and then what was actually provided back to healthcare organization in the form of remittance advice.

Various embodiments of claim reconciliation system may have other inputs. Any data that is helpful in reconciling what billable activities took place with respect to a particular patient versus what was actually received as payment from a fiscal intermediary given the actual billable activities may be included. Other data inputs not necessarily associated with the reconciliation may also be included, as for example, demographic data about patients useful in identifying correlations between patients and/or attributes of patients (age, sex, disease, etc.) and how claims are handled by fiscal intermediary 110 or clearing house 112.

Exemplary claim reconciliation system 1 includes a number of functional software modules 260. The precise number and arrangement of functional modules is an implementation-specific determination. One embodiment of claim reconciliation system 1 is shown with respect to FIG. 2, but other embodiments of claim reconciliation system 1 could combine functional software modules or eliminate some altogether. Claim reconciliation system 1 may reside as instructions on a computer-readable medium, such as a CD-ROM, DVD, computer memory, or a hard drive, which may then be either read by a computer or transferred/copied to other computer-readable mediums then read/executed by a computer, to give rise to functionality described herein.

Claim reconciliation system 1 includes claim database 251. Claim database 251 is the data repository for claim reconciliation system 1. Claim database 251 in one embodiment holds claim data 6, remittance advice data 114, and healthcare organization generated data 250, as well as subsequent and intermediary data generated by functional software modules 260 of claim reconciliation system 1 in the course of analyzing various data inputs. Claim database 251 may also store data resulting from analysis of data inputs, which may in some embodiments be the basis for report generation module 253 to generate reports. In other embodiments, report generation module 253 may do analysis of data itself. Claim database 251 may be implemented in many ways, for example including data storage files, or one or more database management systems (DBMS) executing on one or more database servers. The database management systems may be a relational (RDBMS), hierarchical (HDBMS), multidimensional (MDBMS), object oriented (ODBMS or OODBMS) or object relational (ORDBMS) database management system. Claim database 251 could, for example, be a single relational database such as SQL Server from Microsoft Corporation.

Functional software modules 160 of claim reconciliation system 1, in one embodiment, includes import and merge module 256, conversion module 255, audit module 252, report generation module 253, user interface module 254, and review, edit, and approve module 257. All modules may communicate with each other and claim database 251 as necessary.

Import and merge module 256 receives claim data 6, remittance advice data 114, and healthcare organization generated data 250, confirms, and formats the data to be in a consistent format, determines the type of data, and calls appropriate conversion module 255 if data translations are necessary for incoming data. Whereas import and merge module 256 ensures properly formatted data is brought into claim reconciliation system 1, and may format and otherwise normalize incoming data, where data must be cross-referenced, as from one coding system to another, this is, in one embodiment, functionality contained within the various interfaces of conversion module 255. An interface is a mechanism, often software implemented, for translating one set of codes or communication protocols to another. An exemplary conversion module 255 may include interfaces to a healthcare organization's charge capture system 104, for example, claims as-submitted, and remittance advice. As is necessary, cross-reference tables used by conversion module 255 may be included within claim database 251. Import and merge module 255 may pull information from data sources using scheduled batch processes, or the information may be pulled on demand.

Conversion module 255 may be a dynamically configurable conversion module. In one embodiment, conversion control module applies a set of set of configuration rules, which may be defined using eXtensible Markup Language (XML) format. These rules may be loaded by the conversion module at run-time. The XML rules may configure the conversion module for processing multiple submissions of remittance data and multiple submissions of billing data before inclusion in claim database 251. In other words, the XML rules, in one embodiment, provide the conversion module with the data formats to expect as input and the data formats to produce as output. When changes need to be made to the data format, the XML configuration rules may be modified, thus reducing or eliminating code changes to conversion module 255 itself.

Additional files defining how conversion module 255 processes inputs and produces outputs may be used in combination with the XML file to provide additional processing parameters. Additional files may, for example, allow definition of which carriers to process for output, allow modification of the patient identifier format so as to mach a source database, or exclude data contained in the import which will not be valid for the output.

Conversion module 255 in one embodiment is configured to translate incoming coded medical records, accounting information, and fiscal intermediary remittance information into a tagged format for inclusion in claim database 251, and analysis by audit module 252. Tagged format refers to a means of storing data such that different formats and repeating members of a data set may be accommodated, and the data linked up at a later time. The tagged data format may associate tags that are added to specific types of medical information being imported, thus allowing the data from different databases to be matched up. The tags may even identify certain types of syntax errors that are identified by a parser in the conversion engine. These types of errors may be indicative of data structure problems, as opposed to medical coding, multiple billing, fraud, or other billing problems.

The tagged data format is but one means of dealing with data from a plurality of different systems, with little commonality to their field and naming conventions, but containing an overlapping subset of data. In one embodiment, the tagged data format is comprised of a series of rules which define how data being imported into claim reconciliation system 1, and particularly claim database 251, must be formatted, or what other attributes the data must possess. The tagged data format is a flexible data format that accommodates most healthcare records existing within a healthcare organization, for the most part regardless of originating system. The tagged data format is but one means of linking data from different sources, and in different formats. Other implementations of claim reconciliation system 1 may provide similar functionality in other ways, as the particular implementation requires. For illustrative purposes, and in one embodiment, the tagged data format is as follows:
A singly-occurring field appears in a record only once. For example, a record cannot have more than one Medical Record Number. Multiple-occurrence fields occur more than once: a record can contain more than one Consulting Physician name, for instance.
Subfields are related data fields grouped under a “heading” field. For example, the Address Information field has several subfields pertaining to the patient's address, state, and zip code.
In the tagged data format, each field and its data are formatted into a specific sequence as exemplified in FIG. 3.
A simple example of the tagged format is singly-occurring field such as Visit Number.
   VisitNum:1|97000190
In this example, VisitNum is the tag name, 1 is the occurrence (for singly-occurring fields, the occurrence number is always 1), and since there are not any subfields, an element number is not needed. The 97000190 is the data to appear in the field.
For subfields, the Tagged Data includes which subfield (element number) that the data is intended for. For example:
   ADDRES SMPI.Zip: 1|3|60004
In this example, ADDRESSMPI.Zip is the field identifier for the patient's zip code, 1 is the occurrence number (for singly-occurring fields, the occurrence number is always 1), 3 is the element number, and 60004 is the data to appear in the field.
A tagged format record for multiple-occurrence fields with subfields, such as Consulting Physician, must identify the field name, occurrence number, and since the field has subfields, it must show the element number:
   CONMDINFO.ConMd:2|1|Conner, John
This data is intended for the second occurrence of the Consulting Physician field (ConMDInfo.ConMd), the first element of that occurrence, and the data is “John Conner”.
A more detailed example of a full record as might be imported from, for example ADT system 120, is as follows:
   UnitNum:1|55000
   Name:1|WATSON, JANE RAY
   VisitNum:1|97000191
   SysNum:1|1
   ADt: 1|05031999:2309
   DDt:1|05051999:1200
   ADx:1|V220
   ADxTxt:1|SUPERVISION OF NORMAL FIRST PREGNANCY
   BDt:1|01011965
   Sex:1|F
   Race:1|C
   SSN:1|999999999
   ADDRESSABSTRACT.StreetAbstract:1|1|100 MAIN ST. PO BOX 121
   ADDRESSABSTRACT.CityAbstract:1|1|CENTERVILLE
   ADDRESSABSTRACT.StateAbstract:1|1|MI
   ADDRESSABSTRACT.ZipAbstract:1|1|48706
   ATTMDINFO.AttMd:1|1|5002
   CONMDINFO.ConMD:1|1|5002
   CONMDINFO.ConDt:1|1|05031999
   DISPINFO.Disp:1|1|H
   TtlChgs:1|1800.23
   EOR:
Other rules also define the tagged format. These rules may be required or disregarded depending on the implementation. Examples of these other rules include:
1. Each record to load must include system number (1—inpatient, 2—outpatient, 3—emergency) in the SysNum tag.
2. Each patient record in the inbound or outbound files must end with the EOR: (end of record) tag.
3. Each record must include the patient Medical Record Number (UnitNum).
4. Each record must include the patient Account Number (VisitNum).
5. There cannot be any spaces between the data and the <CR><LF> characters.
6. Admit and Discharge Date/time field(s) are formatted with a colon (:) separating the date and time: MMDDCCYY:HEIMM. All other dates are formatted as MMDDCCYY.
   As mentioned, FIG. 3 is an exemplary schematic of a field showing a particular formatting sequence. In the tagged data format, each field and its data are formatted into a specific sequence as exemplified in FIG. 3. Tag name TDS1 is the tag name, which may also be the field identifier. Occurrence number TDS2 is the occurrence number of the field where the data should be stored, for multiple occurrence fields only (repeating fields). Element number TDS3 signifies a particular sub-field of tag name TDS1. Data TDS7 is the data. The remaining elements in FIG. 3 refer to formatting characters (colon TDSS, pipe character TDS6, carriage return TDS4, and line feed TDS8).

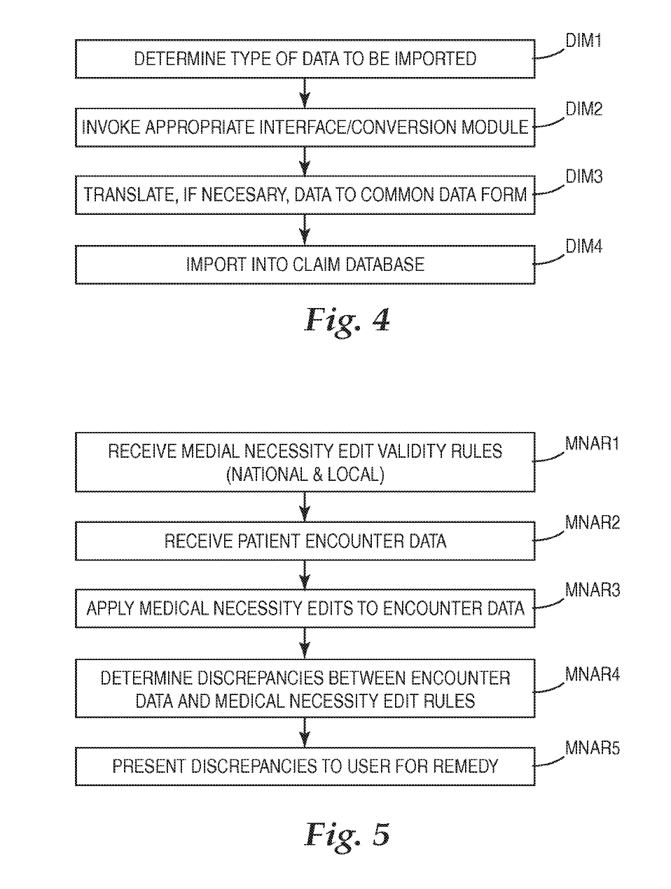

An embodiment of the operation of import and merge module 256, in combination with conversion module 255, is shown with respect to FIG. 4.

FIG. 4 shows an exemplary manner in which import and merge module 256 may function, sometimes in combination with conversion module 255, to receive data from various sources in various formats, convert or translate it to a common format, the tagged format, as necessary, and then import it into claims database 251.

First, data import and merge module 256 determines the type of data that is being imported (DIM1). This information is, in various embodiments, supplied by the user, supplied as part of the routine that invoked import and merge module 256, or determined by import and merge module 256 based on information available to it, such as the formatting of the data to be imported, or meta data included with the data to be imported.

Next, import and merge module 256 determines whether a translation of data is required to get it into a consistent format used within claim database 251. If so required, import and merge module 256 calls conversion module 255 (DIM2), which translates the incoming data to a common form using XML, files mentioned above (DIM3). If no translation of data is required (for example, some systems may export data directly into a format consistent with claim database 251, the step is skipped. The data is then loaded into claim database 251 (DIM4).

Data retrieved by or provided to import and merge module 256 is associated initially by the patient to whom the data is related. Billable services and procedures associated with the patient are thus associated with a specific patient. Data is imported into claim database 251 may include both the claim data generated within healthcare organization itself, as well as the resulting remittance advice received along with payment from fiscal intermediary 110. Because all data is within common data repository (claim database 251), associated by an data association mechanism such as the tagged data format, the healthcare organization may be able to identify which patient records need to be re-billed if billing regulations change, for example.

Because, in part, import and merge module 256 puts data inputs into a consistent format (the tagged data format, in this example) and uses conversion module 255 to translate the data inputs as necessary, claim database 251 is populated with data which may be matched up and compared in ways that would be difficult had the data not been placed in consistent format and translated as necessary. As will be seen, an auditor may use interface module 254 to review differences between what was coded by a healthcare organization, what was billed by the healthcare organization, and what was actually received as payment by the fiscal intermediary. Reports, from report generation module 253 (further detailed below) may help ensure that all authorized proper codes were actually present on the claim as submitted to the fiscal intermediary 110 for payment. If all proper codes are found to not have been included on a bill, discrepancies may be noted and used for correction and/or educational purposes. Comparisons between claim data submitted to fiscal intermediary 110 and remittance advice data showing what was actually paid by fiscal intermediary 110 may also serve as an audit of fiscal intermediary 110 to ensure it is processing claims submitted by or on behalf of healthcare organization properly.

Import and merge module 256 may accommodate importation of multiple claims associated with services rendered to a patient. For example, if a claim is reissued to a fiscal intermediary for payment, as would be the case for example, if regulations have changed and it is still possible to re-submit the claim, import and merge module 256 may import each of these claims into claim database 251, each matched to an individual patient via the patient's record. Import and merge module 256 also accommodates multiple remittance advice records to be stored for each claim. Sometimes fiscal intermediaries pay a claim in multiple payments, rather than a single payment, each payment including its own remittance advice 114. The importation of multiple claims associated with a patient's visit to a healthcare organization, or multiple remittance advices associated with the payment of a claim made to a fiscal intermediary, may provide a basis for robust auditing features of claim reconciliation system 1, and in particular may provide a basis for corroborating information to audit data describing services rendered to a patient versus eventual payment made for those services.

As mentioned, import and merge module 256 calls conversion module 255 as necessary. Conversion module 255 has a number of interfaces to interpret, translate, and/or confirm data received from various sources. One example interface operate to facilitate communications and data transfer with another system that holds information concerning what procedures and treatments were done with regard to a patient. Such a system may be called a charge capture system, but in various implementations functionality underlying the system may be encompassed in the healthcare organization's billing system 99 or accounting system 109. Regardless of the source, the data imported contains charge-level information for a patient's encounter with a healthcare organization. The interface may specify a format for incoming data, as well as standard field names, flat file definitions (starting positions if data is contained on one row, for example, as well as length), whether the field is required, and comments.

The interface may also define and enforce relationships between data being imported. Continuing the charge-level detail interface example introduced above, the interface may group charge detail data associated with a charge level record. Charge detail data is additionally defined, and may include, for example, actual charge level information, which includes all detailed charge records with a complete listing of debits and credits (revenue-level information), which includes all detailed charge records with a common procedure code (procedure-level information), which includes all detailed charge records with a revenue code and charge amount but without a common procedure code. The above are only examples. Specific interfaces will vary from implementation to implementation, but will generally serve to take data from sometimes disparate sources and import it into a common database. FIG. 4 further illustrates an exemplary working of the import and merge module 256, in combination with conversion module 255.

Audit module 252 analyzes data in claim database 251. Routines and processes within audit module 252 may provide, for example, notifications or alerts presented to the user via user interface module 254, alerting the user to an error or issue that needs to be addressed before sending data describing a patient encounter to the billing department. At a high level, audit module 252 iterates through data contained in claim database 251 and determines whether the claim data comports with validity rules. Validity rules may define both real issues and potential issues. Validity rules, for example, may define which procedure codes (often called CPT codes) are supported by which diagnosis codes. Validity rules also define all, or a subset of, rules known to be applied by a payment organization, via the fiscal intermediary, before paying a claim. Other types of validity rules define, for example, procedure codes that are inconsistent with patient demographic data (for example, a procedure only associated with a female should not be on a claim submitted for a male (for example, CPT codes associated with pregnancy)). The application of validity rules to data held within claim database 251 yields issues, potential issues, and suggestions. Issues, potential issues, and suggestions are all termed “edits.” Issues exist where a rule that will be applied by a fiscal intermediary has been applied by audit module 252, and does not evaluate in a manner consistent with payment. Potential issues, also termed potential edits, exist where a rule may or may not evaluate in a manner consistent with payment, depending on an ambiguity. Suggestions are the result of the application of validity rules that attempt to identify missed or overlooked billings. For example, an issue is where a condition precedent a billing has not been satisfied, as for example, where there has been no documented diagnosis in support of the administration of a drug or procedure to a patient. A suggestion would be, for example, where a drug was associated with a patient and will be included on a claim, but there is no code in support of the administration (injection or infusion) of the drug to the patient. Audit module 252 may present to a user, in such circumstance, a screen to confirm whether there should be a charge associated with the administration of the drug. Edits may be resolved to the satisfaction of the user.

Validity rules may be hard coded into claim reconciliation system 1, or may be accessed by claim reconciliation system 1 via a set of files, as for example XML files that define relationships among data within claim database 251.

Audit module 252 may apply validity rules associated with National Coverage Decision (NCD), and present resulting edits at the point of medical coding. NCD rules are just one further example of validity rules that may be applied by audit module 252. NCD edits are established by the Centers for Medicare and Medicaid Services, and help Fiscal Intermediaries determine whether a medical diagnosis justifies tests and procedures for which payment is requested. Another set of edits are Local Coverage Decision (LCD) edits. LCD defines how local carriers must review claims to ensure they meet Medicare coverage and coding requirements (in addition to what NCDs cover). LCDs are often created by fiscal intermediaries and may change more frequently, sometimes as often as every 30 days. Validity rules associated with LCDs and NDCs are applied, in one embodiment, by audit module 252, yielding new edits. Claim reconciliation system 1 may allow user to view edits real time or in batch mode. It also may provide for the application of validity rules before the claim is generated and submitted, therefore allowing a user such as a medical coder to request complete documentation from a physician provider, for example, so that medical diagnosis justify services rendered, with full documented support in the records (in other words, the claim audit should yield no edits.) A further set of validity rules defines relationships between ICD-9-CM diagnosis codes and CPT codes. These validity rules are merely examples—many other validity rules could be developed and applied by audit module 252.

FIG. 5 shows an exemplary process that may be functionally invoked and effected by audit module 252. In this example, audit module 252 may have been invoked by a user via user interface module 254 before data is sent to a billing department, where a claim is to be assembled from data, internal to healthcare organization, describing a patient's encounter with the healthcare organization. First, rules defining medical necessity edits are retrieved from claim database 251 (MNAR1) (this example presumes they have already been imported via import and merge module 256, possibly in combination with conversion module 255—if the data does not exist, however, audit module 254 may in one embodiment specify that import and merge module 256 should retrieve the necessary data: such a pull of data is possible for any data needed or beneficial to audit module 252 or any other module within claim reconciliation system 1, and any time or as specified by user). Next, audit module 252 receives patient encounter data (MNAR2). This data may not be a claim per se, but is instead data internal to a healthcare organization that defines and describes a patient encounter (services rendered, some of which are likely billable, for example). This encounter data is, or may become, the basis for a claim. The encounter data may be pulled from claim database 251. Next, audit module 252 compares encounter data and medical necessity edit rules, applying validity rules that define the typical relationship the two should have (MNAR3). This analysis may yield, for example, information specifying that a condition precedent a particular billing is not present in the encounter data (MNAR4). Such discrepancies are presented to a user of the claim reconciliation system 1 (MNARS), and the user may then edit underlying encounter data and request the reconciliation system to push the updated data out to the original sources for update, or have the claim reconciliation system notify a responsible department, which in turn can do the same, as appropriate.

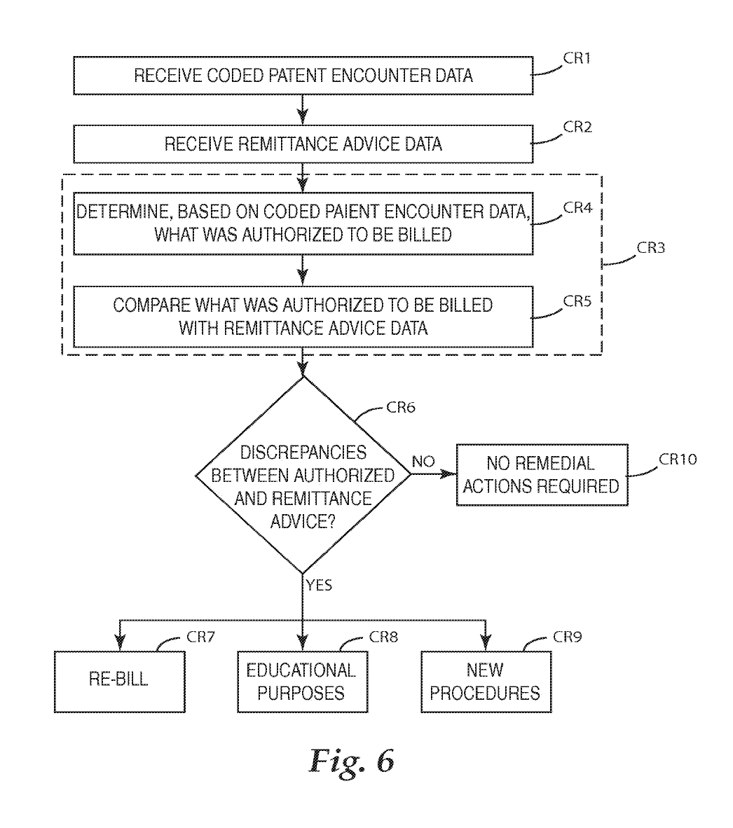

FIG. 6 shows a further exemplary process that may be functionally invoked or effected by audit module 252. In this example, patient encounter data is analyzed in light of remittance advice data as received from a fiscal intermediary. First, coded patient encounter data is retrieved by audit module 252 (CR1). As mentioned earlier, patient encounter data is not necessarily the data submitted on a claim per se, but is the data that the claim was derived from which describes the patient's encounter with the healthcare organization. The encounter data may differ from the data appearing on the claim. The coded patient encounter data, in this example, has been pre-loaded into claim database 251, so the encounter data is pulled from this database. Next, remittance advice data is retrieved (CR2). Remittance advice data, in this example, has similarly been previously loaded into claim database 251 by the import and merge module 256 (possibly in combination with conversion module 255). Next, a two step process is performed on the data that cumulatively may be thought of as applying validity rules (CR3). The first of these two steps is to determine, based on the coded patient encounter data, what was in fact authorized to be billed (CR4). This may result in, for example, items A, B, C, and D. The second of the two steps is to compare what was authorized to be billed, with what was in fact paid, per remittance advice records (CR5). This step may determine that B and C were in fact paid. Next, if there are discrepancies between what was authorized to be billed and the remittance (CR6), these discrepancies may be, depending on the circumstances, re-billed (CR7), used for educational purposes (CR8), or used to develop new procedures (CR9). In this example, the discrepancies would be A and D. If there are no discrepancies, no further remedial action is necessary (CR10). Audit module 252, having completed analysis of data, may optionally store that data in claim database 251.

User interface module 254 in one embodiment facilitates human interaction with claim reconciliation system 1 and associated functionality. A claims auditor, for example, may interact with user interface module 254, in an effort to audit records for quality assurance purposes. Screen shots generated by user interface module 254 are presented and discussed elsewhere in this specification. User interface module 254 may be implemented on a web server, such as IIS, available from Microsoft Corp. of Redmond, Wash., or for example it may exercise an operating system's native graphical user interface functionality (such functionality may be provided by any graphical user computing environment, such as that marketed by Microsoft Corp. of Redmond, Wash., under the trade designation Windows). User interface module 254, in one embodiment, generates a plurality of screens and/or windows that control other functional software modules 260.

Report generation module 253 pulls data from claim database 251 to generate reports for a user of claim reconciliation system 1. Reports generated from report generation module 253 may, for example, compare medical procedures submitted to fiscal intermediary 110 as claims against payments received by the fiscal intermediary. Any non-compliant or error-containing records may be flagged in the report for further analysis or revision.

Report generation module 253 is, in one embodiment, controlled via user interface module 254. In other embodiments, report generation module may provide for generation of reports on a regular, scheduled basis, as for example once per month, or based on other events (when certain claim data is retrieved by import and merge module 256, for example). Report generation module 253 may include pre-defined reports. For example, one such report may provide the percentage of claims with outstanding edits, the types of errors that occurred on the claims with edits, and the department or departments likely responsible for the errors. These reports may help identify problematic trends and opportunities for process improvement or education.

Another exemplary predefined report run by report generation module 253 is one which compares medical claims that have passed edits and have been authorized for final billing with bills generated by a billing process to determine whether non-compliant codes are present. Reports can also be generated which identify the types of errors that are still on a claim at the point of billing, which departments are responsible for the errors, and how long it has taken to obtain requested documentation from departments within the healthcare organization. Reports may also show various views of the patient population the healthcare organization serves. For example, reports from claim reconciliation system 1, via report generation module 253, may provide the types of treatments provided to particular patients from a given zip code, or which services are performed most frequently and financial data associated with these services. This financial data may include, for example, profitability or revenue.

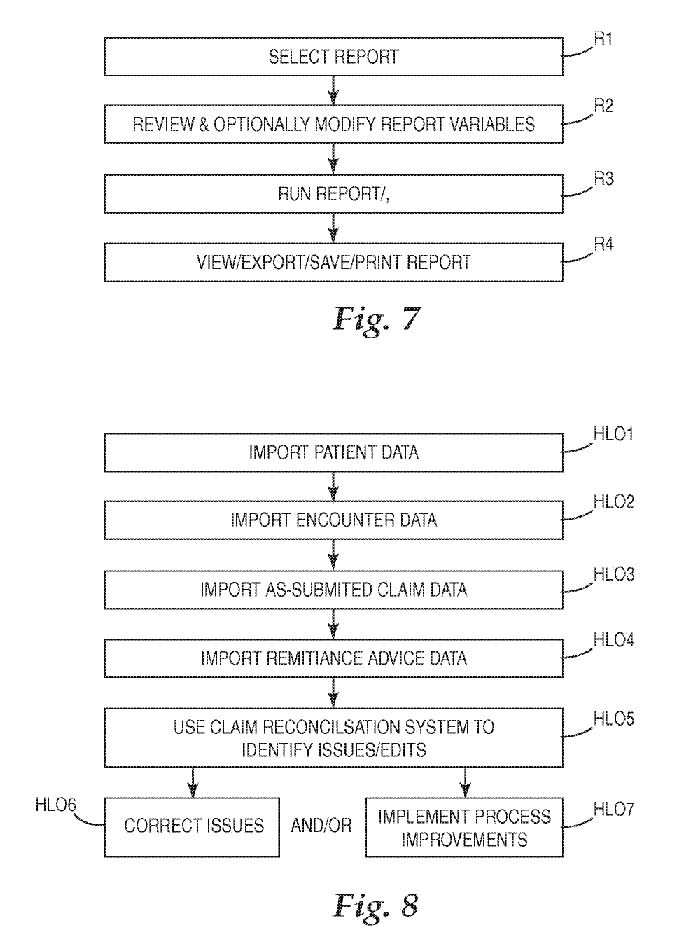

FIG. 7 is a flowchart showing exemplary functionality of report generation module 253. First, a report is selected (R1). This may be done via a user selecting a particular report from a user interface generated by user interface module 254. The report may be pre-specified and selected from a saved list of reports, or it may be assembled ad-hoc by the user (R2). Next, the report is run (R3). In one embodiment, report generation module 253 pulls data from claim database 251, but may also invoke audit module 252 as necessary to provide analysis on various data, as required by the report requested by the user. Finally, the report is presented to the user (R4). The report may be saved back to claim database 251 for retrieval. It may also be exported to various formats, such as HTML or PDF, as specified by the user.

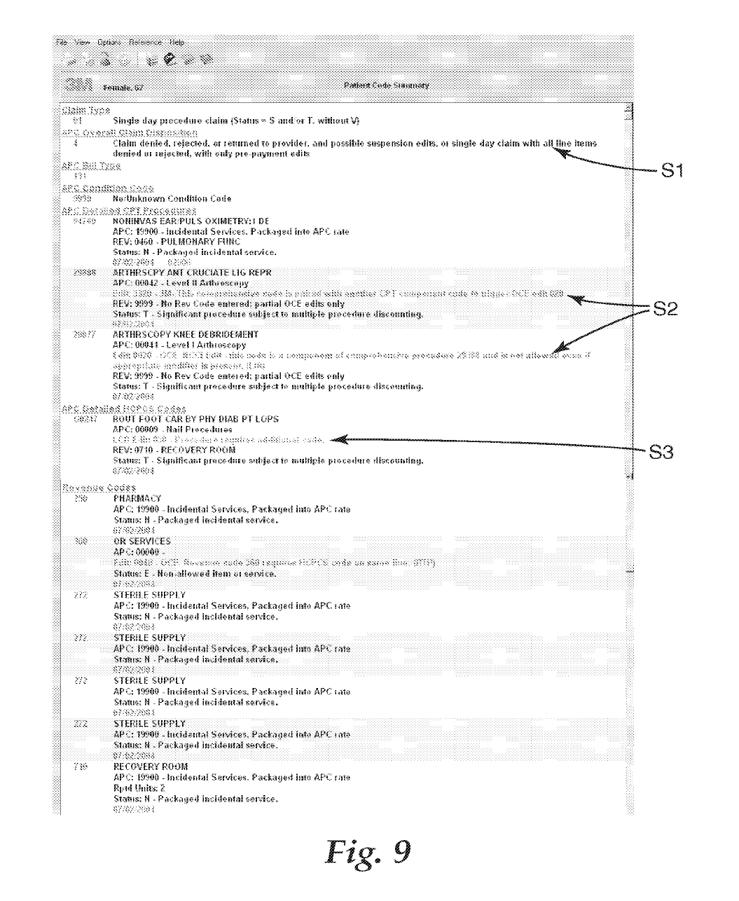

FIG. 8 shows an exemplary high-level process a user may use claim reconciliation system 1 to follow. First, patient data is imported (HLO1). Patient data identifies and in some embodiments describes the patient, such as the name, address, an identifier, and other related data. Next, encounter data is imported (HLO2). This data describes the patient's encounter with the healthcare organization. As mentioned above, encounter data is not the claim itself, but the data precursor to a claim. Encounter data may be formatted in a variety of ways; the import and merge module 256 translates the data as necessary into a common format, in one embodiment the tagged format also mentioned above. Claim data, which defines and describes the claim-as-submitted, is then imported (HLO3). Next, remittance advice data, which defines and describes what was paid by a fiscal intermediary based on the claim data, is imported into claim database 251, and thus claim reconciliation system 1 (HLO4). As mentioned previously, the presence of remittance advice data is not necessary. It may be needed for audit module 252 to analyze past billings in light of what was received per the remittance advice record, but there are other functions of claim reconciliation system 1 where remittance advice data is not needed, as for example where the audit module 252 is reviewing data before it is even assembled as a claim. With requisite data loaded into claim database 251, the claim reconciliation system 1 identifies issues and edits (real, potential, or suggested) (HLO5). Issues identified may be corrected (HLO6), or may be used to identify and implement process improvements (HLO7), for example.

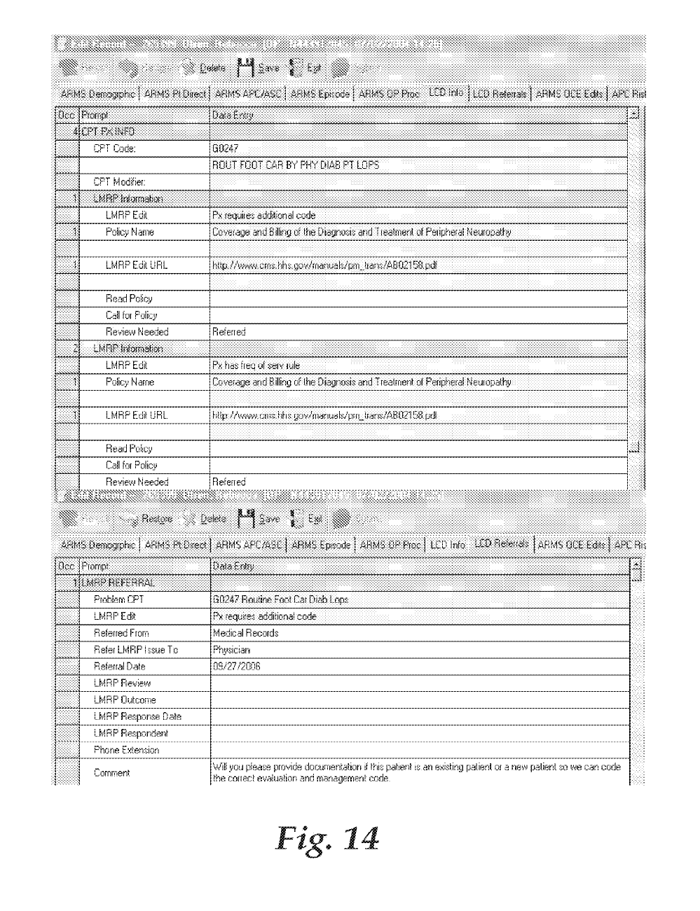

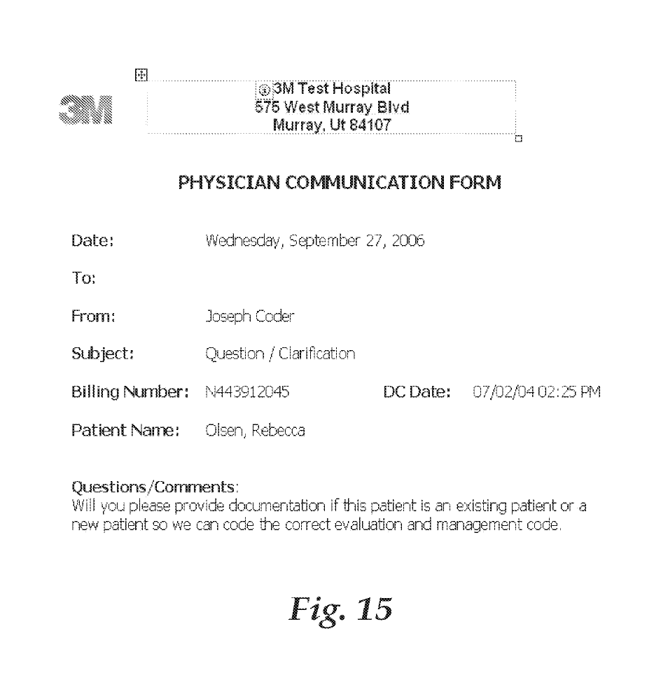

Review, edit, approve module 257 facilitates the review, edit, and approval of data imported into claim database 251. In some embodiments it may also facilitate pushing edits made to data back out to the data's source. For example, an edit may be generated on a radiology code based on erroneous data coded into a charge system. The erroneous data may be such that only authorized individuals responsible for the coding can correct it. Review, edit, approve module 257 may in some embodiments notify the responsible department of the error and request correction. When the department does correct the problem, a credit and debit may be issued, and the new resulting corrected data imported into claim system. Alternatively, in the case of LCD edits, the edits may need to be referred to a physician to request more complete documentation and determine if the added documentation will lead to a correction of the LCD edit. This is further shown with respect to FIG. 14 and FIG. 15.

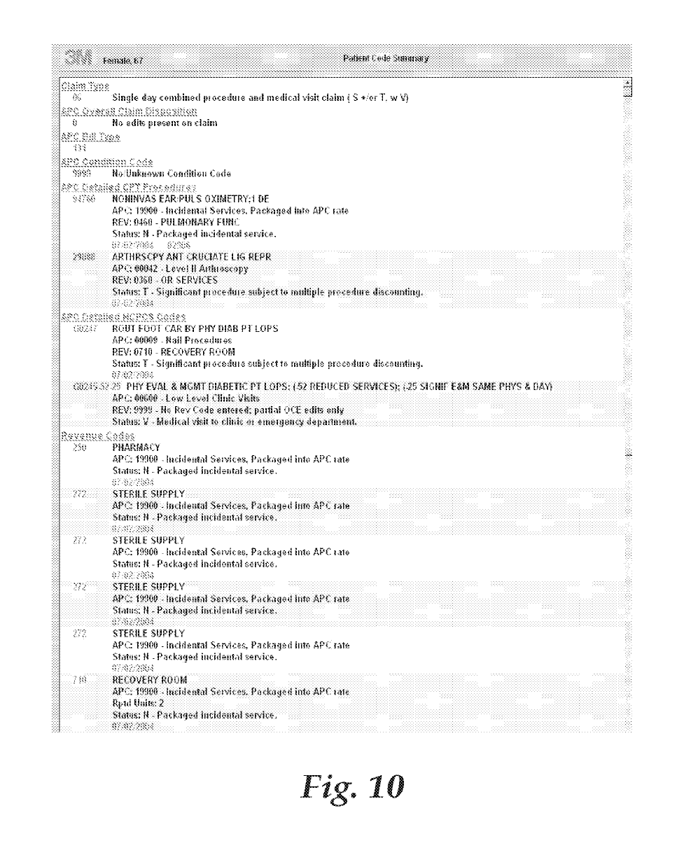

FIG. 9 through FIG. 15 are exemplary screenshots as might be generated by user interface module 254 of claim reconciliation system 1. User interface module 254 may generate user interfaces captured in these screenshots via hyper-text markup language (HTML), a web-server, and a web-browser as client. Alternatively, the user interface may be generated other known ways, readily apparent to one skilled in the art. Overall encounter disposition S1 indicates the current disposition of the encounter analyzed by audit module 252, possibly in preparation for generation of claim. Edits S2 show edits, in this case errors, that need to be remedied for payment of the associated claim, or an edit indicating the claim as it is may not be allowed. LCD edit S3 is a local condition code edit indicating the fiscal intermediary requires another procedure code to demonstrate and substantiate medical necessity, which is required by the fiscal intermediary in order to authorize payment by the payment organization.

FIG. 10 shows a screen as might be shown after edits noted on FIG. 9 have been addressed.

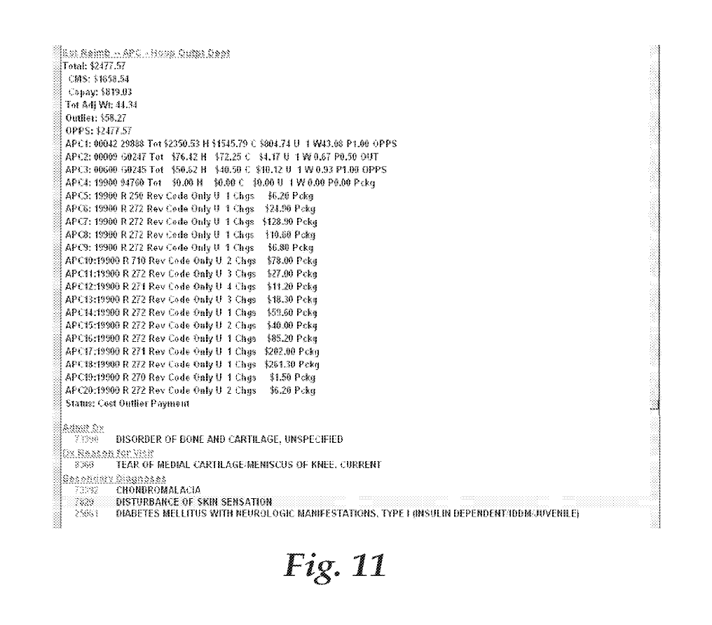

FIG. 11 shows estimated reimbursements based on underlying patient encounter data.

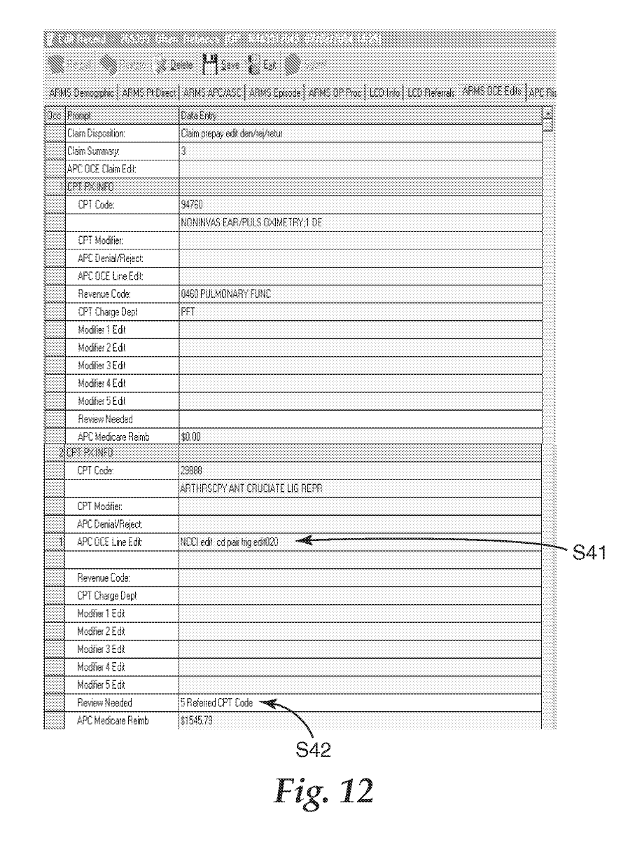

FIG. 12 shows one view of a record in the claim database. Data field S41 shows that for CPT code 29888, a corresponding edit exists. Data field S42 indicates the error underlying the edit is being referred else ware (possibly to the department responsible for the underlying data for correction or amendment, though this information is not shown in FIG. 12). User 105 may review and edit records using an interface similar to FIG. 12. The functionality exercised behind FIG. 9 through FIG. 12 is at least in part that of review, edit, and approve module 257.

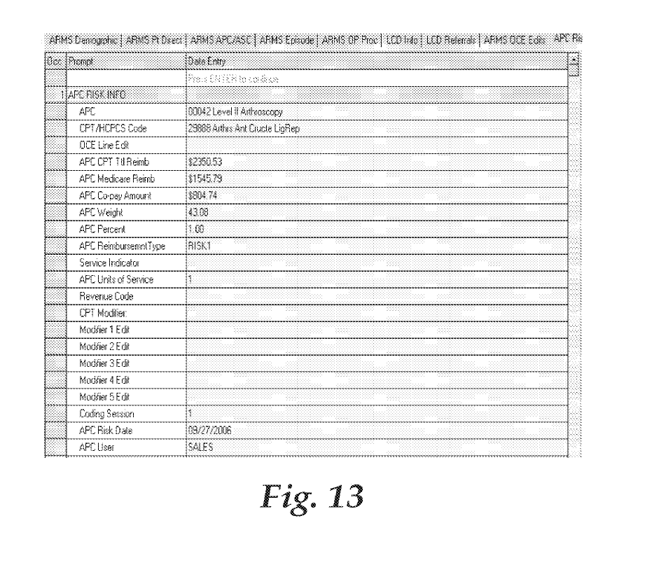

FIG. 13 shows a drill-down from data presented in FIG. 12. It shows the amount of revenue at risk for a particular code, 29888, that has an outstanding edit. User 105 may use this type of information to prioritize the edits to be addressed by the healthcare organization.

FIG. 14 is similar to FIG. 12, but shows local edits effected by, for example, the fiscal intermediary.

FIG. 15 shows an exemplary communication that may be generated by claim reconciliation system 1. The communication in FIG. 15 invites an unspecified recipient (see FIG. 12) to provide further documentation.

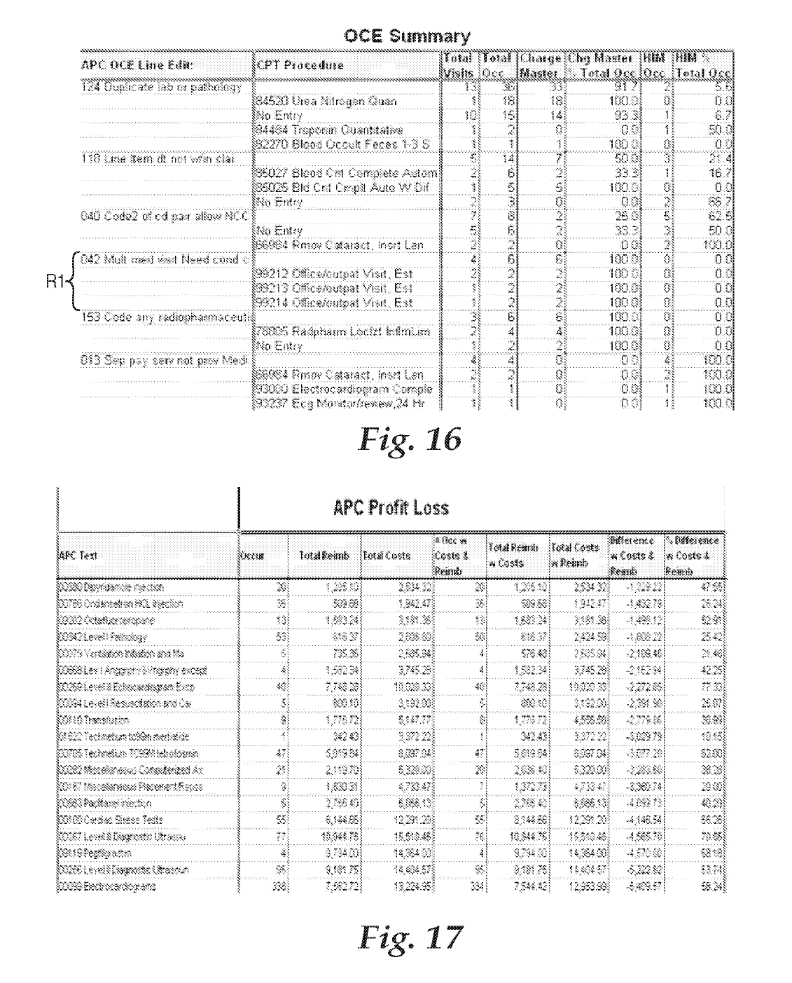

FIG. 16 through FIG. 19 are exemplary reports as might be generated by report generation module 253 of claim reconciliation system 1.

FIG. 16 shows types of errors that originate from charge capture system 104. Edit R1 may be read by one skilled in the art to indicate the associated CPT procedure codes need a condition code. User 105 may see this report and assign a person to add the condition code.

FIG. 17 shows a profit/loss report on Medicare payment for outpatient services based on Ambulatory Payment Classifications.

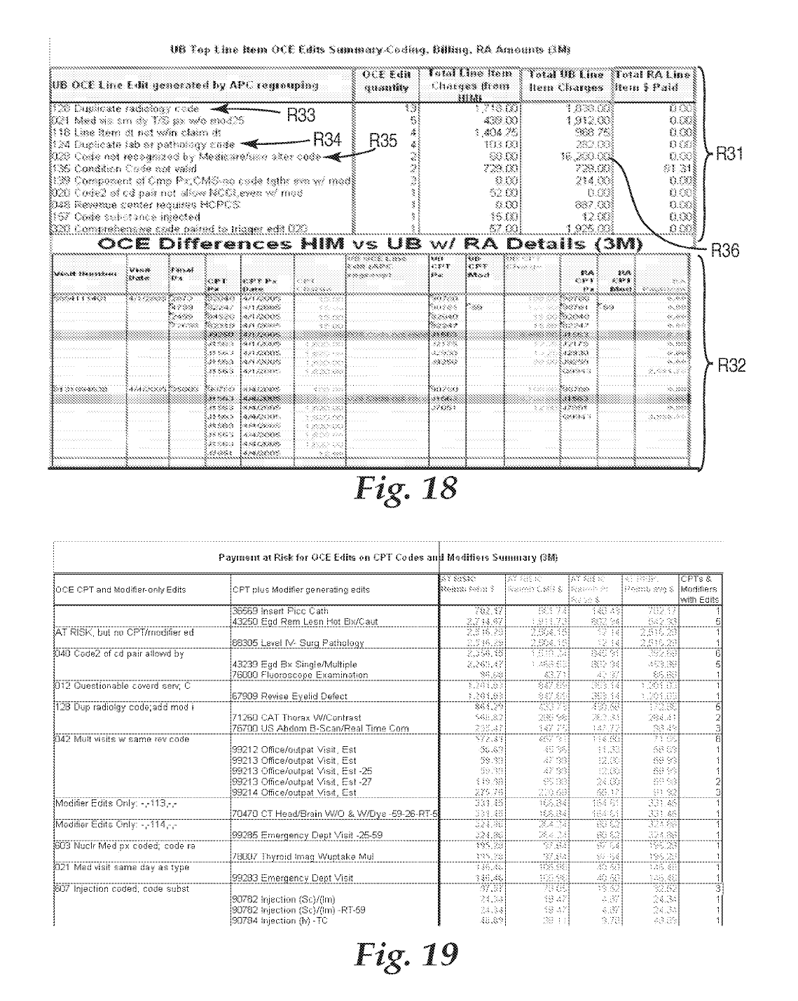

FIG. 18 shows two different report views of the same underlying data. View R31 shows potential compliance issues R33, R34, and R35. Charge amount R36 indicates potential lost revenue from two OCE edits. View R32 shows which records have the two errors. Views R31 and R32 are one example of a report generated from an analysis of claim data and remittance advice data.

FIG. 19 shows the amount errors are costing the healthcare organization, in this case a hospital, in terms of expected payment, by payer, in this case CMS (the government) and patient co-pay.

It is to be understood that the above-described compositions and modes of application are only illustrative of preferred embodiments of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein.

1. A computer-implemented method comprising:
receiving patient encounter information that defines, at least partially, a patient's encounter with a healthcare organization, the patient's encounter including at least one service provided to the patient;
receiving remittance advice information that defines payments made to the benefit of the healthcare organization for at least one service provided to the patient and associated with the encounter;
receiving as-submitted claim data that defines one or more requests for payments, the requests made to a payment organization for the at least one service provided to the patient;
applying a set of rules to the patient encounter information, the remittance advice information, and the as-submitted claim data, the set of rules defining relationships between the as-submitted claim data and either or both of: the patient encounter information and the remittance advice information; and
based on the application of the rules, identifying a discrepancy between the as-submitted claim data and either or both of: the patient encounter information and the remittance advice information.

2. The computer-implemented method of claim 1, wherein the discrepancy identified between the as-submitted claim data and the patient encounter data is a claim or part of a claim that will not be paid.

3. The computer-implemented method of claim 1, wherein the discrepancy identified between the as-submitted claim data and the remittance advice information is a claim or part of a claim that was not paid.

4. The method of claim 1, further comprising:
presenting the discrepancy to a user.

5. The computer-implemented method of claim 1, wherein the payment organization is a government organization

6. The computer-implemented method of claim 1, wherein the payment organization is an insurer.

7. The computer-implemented method of claim 1, the method further comprising:
presenting, via an electronic user interface on a computer, the discrepancy to a user;
receiving from the user input defining how to change the patient encounter information to remedy the discrepancy; and
based on the input received from the user, changing the patient encounter information.

8. The computer-implemented method of claim 7, wherein changing the patient encounter information comprises sending data describing the same to other computer systems from which the patient encounter information originated.

9. The computer-implemented method of claim 7, further comprising:
submitting a claim that includes the changed patient encounter information.

10-11. (canceled)

12. A computer-implemented method comprising:
receiving patient encounter information that defines, at least partially, a patient's encounter with a healthcare organization, the patient's encounter including at least one service provided to the patient;
receiving claim data that defines one or more requests for payments, the requests made to a payment organization for the at least one service provided to the patient;
applying a set of rules to the patient encounter information and the as-submitted claim data, the set of rules defining relationships between the sets of data; and,
based on the application of the rules, identifying a discrepancy between the as-submitted claim data and the patient encounter information.

13. The computer-implemented method of claim 12, wherein the claim data has not yet been submitted for payment.

14. The computer-implemented method of claim 12, wherein the claim data has been submitted for payment.

15. The computer-implemented method of claim 12, wherein the identified discrepancy between claim data and the patient encounter information is a condition wherein further chargeable services could be included in the claim data, and these further chargeable services would be paid if they would be included in the claim data.

16. The computer-implemented method of claim 12, wherein the identified discrepancy between claim data and the patient encounter information is a condition wherein the claim data includes at least one claim that is not sufficiently supported by the patient encounter information.

17. The computer-implemented method of claim 16, wherein the claim that is not sufficiently supported by the patient encounter information because a condition precedent the payment of the claim is not present in the patient encounter information.

18. The computer implemented method of claim 16, the method further comprising:
presenting to a user, via a user interface, the discrepancy; and, receiving input from the user indicative of how the discrepancy should be resolved.

19. The computer-implemented method of claim 18, the method further comprising:
modifying patient encounter information consistent with the user input indicative of how the discrepancy should be resolved.

20. A computer-implemented method comprising:
receiving remittance advice information that defines at least one payment made to the benefit of a healthcare organization for at least one service provided to a patient as part of the patient's encounter with the healthcare organization;
receiving as-submitted claim data that defines one or more requests for payments, the requests made to a payment organization for the at least one service provided to the patient;
applying a set of rules to the remittance advice information and the as-submitted claim data, the set of rules defining relationships among the sets of data; and,
based on the application of the rules, identifying a discrepancy between the as-submitted claim data and the remittance advice information.

21-30. (canceled)
